(19) United States
(12) Patent Application Publication
(10) Pub. No.: US 2017/0220069 A1
(43) Pub. Date: Aug. 3, 2017

(54) DOCKING APPARATUS AND CONTROL METHOD THEREOF

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HUNG-CHANG LIN, New Taipei (TW); CHENG-HUNG LIN, New Taipei (TW)

(21) Appl. No.: 15/009,170

(22) Filed: Jan. 28, 2016

(51) Int. Cl. G06F 1/16; G06F 13/364; G06F 13/42

(52) U.S. Cl. CPC G06F 1/1632; G06F 13/4282; G06F 13/364

(57) ABSTRACT

A method for controlling a docking apparatus using a portable electronic device permits enhanced functionality for the portable electronic device. In the control method, the docking apparatus receives I²C messages in a first byte format from the portable electronic device over a first I²C bus. The docking apparatus translates the I²C message from the first byte format to a second byte format and transmits the translated I²C message over a second I²C bus to an I²C-compatible device.

### FIELD

The subject matter herein generally relates to a docking apparatus, and more particularly, to a docking apparatus configured to connect with a portable electronic apparatus to expand input and output functions of a portable electronic apparatus and control method thereof.

### BACKGROUND

A portable electronic apparatus necessarily has limited space for hardware components. Accordingly, the display of a portable electronic apparatus is limited in size, which creates difficulties in displaying images and playing videos as in conventional computing.

### BRIEF DESCRIPTION OF THE DRAWINGS

Implementations of the present technology will now be described, by way of example only, with reference to the attached figures, wherein:

FIG. 1 is a block diagram of one embodiment of a docking system as disclosed.

FIG. 2 is a block diagram of one embodiment of a serial bus structure of a docking system as disclosed.

FIG. 3 is a schematic of one embodiment of byte format of I²C messages for transmission in a docking system as disclosed.

FIG. 4 illustrates a flowchart of one embodiment for I²C message translation in a docking system as disclosed.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like. The term “portable electronic apparatus” refers to an electronic device that is small enough to be carried conveniently by a person. The term “docking apparatus” refers to an apparatus capable of receiving and communicating with a portable electronic apparatus, in particular a self-contained portable electronic apparatus, so performance of the portable electronic apparatus is enhanced, or additional functionality is provided to the portable electronic apparatus.

The present disclosure is described in relation to a docking apparatus for a portable electronic apparatus that provides electrical charging or recharging, and enhanced functionality.

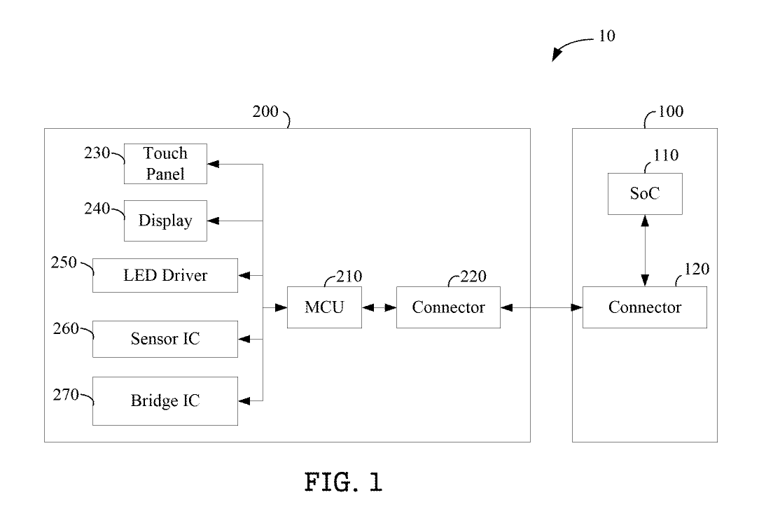

FIG. 1 illustrates a docking system 10, in accordance with an embodiment of the invention. The docking system 10 comprises a portable electronic apparatus 100 and a docking apparatus 200. The portable electronic apparatus 100 may be any number of small handheld devices, such as, for example, smart phones, game pads, or portable digital assistants (PDAs). The portable electronic apparatus 100 may comprise multiple hardware components such as input devices (not shown), output devices (not shown), a System-On-Chip (SoC) 110, and a connector 120. Such input devices may comprise, for example, a camera, a microphone, a touch screen, a touchpad, buttons and/or hard switches. The output devices may comprise, for example, a display and/or a speaker. The SoC 110 is a multi-functional processing unit having multiple processors on a single chip, each processor designed for a specific class of tasks. The SoC 110 may comprise a CPU, a video processor, an image processor, an audio processor, and a memory. The portable electronic apparatus 100 can be connected to the docking apparatus 200 using the connector 120. The connector 120 is configured for electrically connecting/mating to a connector 220 of the docking apparatus 200 and enables communication and power transfer path between the portable electronic apparatus 100 and the docking apparatus 200. The docking apparatus 200 may comprise multiple hardware components, such as a microcontroller unit (MCU) 210, a touch panel 230, a display 240, a light-emitting diode (LED) driver 250, a sensor integrated circuit (IC) 260, and a bridge IC 270. The touch panel 230 comprises a touch-sensitive surface, a sensor or set of sensors, and the touch panel 230 provides an input interface and an output interface between the docking apparatus 200 and a user. A stylus or other object may be used for interacting with the touch panel 230. The display 240 may take the form of a liquid crystal display (LCD), an LED display, or any type of display suitably large for ease of viewing. The display 240 comprises the touch panel 230 overlaying the entire display (or a portion thereof) and the LED driver 250 controls backlighting for the display 240. Moreover, the docking apparatus 200 provides a display with a larger size than the display of the portable electronic apparatus 100. The bridge IC 270 performs a function of converting format of image data received from the portable electronic apparatus 100 to a format that the display 240 is able to receive and display. The bridge IC 270 may convert, for example, Mobile High-definition Link (MHL) data to High Definition Multimedia Interface (HDMI) data. Further, the bridge IC 270 may convert HDMI data to Mobile Industry Processor Interface (MIPI) data. The display 240 converts image data received from the bridge IC 270 to an analog signal and can display the analog signal. The sensor IC 260 comprises a light sensor, such as a phototransistor, to continuously measure ambient light conditions that are associated with the display 240. The light-level signal of the sensor IC 260 is utilized by the LED driver 250 for driving the backlighting.

An operating system (OS) and software applications are executed by the SoC 110 and coordinate and provide control of the portable electronic apparatus 100. The software applications may detect connection and disconnection events when the portable electronic apparatus 100 is connected (docked) or disconnected (undocked) to or from the docking apparatus 200. The connectors 120, 220 may provide communication interfaces between the portable electronic apparatus 100 and the docking apparatus 200. Hardware components that are integrated into the docking apparatus 200 may be controlled by the portable electronic apparatus 100 when the portable electronic apparatus 100 is fully docked with the docking apparatus 200. For example, when the portable electronic apparatus 100 is connected to the docking apparatus 200, the touch panel 230 is enabled and can be used as an input device of the docking system 10. The touch panel 230 generates a signal when touched. The touch signal is transmitted to the portable electronic apparatus 100 and processed by the SoC 110. Then, the SoC 110 generates an output, and the output information is transmitted to the docking apparatus 200 and displayed at the display 240. When the portable electronic apparatus 100 is connected to the docking apparatus 200, the display of the portable electronic apparatus 100 may also be used as a secondary display while the display 240 of the docking apparatus 200 may be used as a primary display. The primary display may be used to display higher priority image data whereas the secondary display may be used to display lower priority image data. The primary display may also be used to display the same image data as that displayed on the secondary display. The interaction between the secondary display and the primary display is controlled by the OS and the software applications executed by the SoC 110.

In addition, the SoC 110 may perform bi-directional communication between the portable electronic apparatus 100 and the docking apparatus 200 over the connectors 120 and 220. More specifically, communication between the portable electronic apparatus 100 and the docking apparatus 200 uses a bi-directional communication bus which is a serial bus based on the inter-integrated circuit (I²C) bus specification.

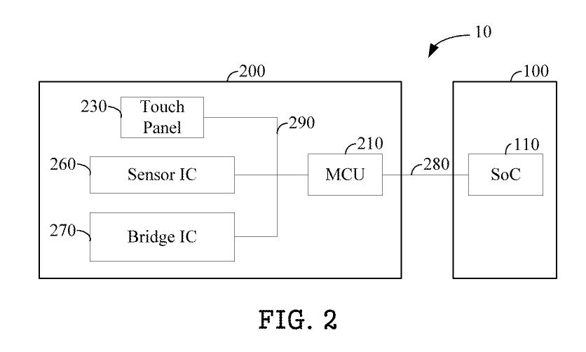

FIG. 2 illustrates a serial bus structure of the docking system 10 in accordance with an embodiment of the invention. Referring to FIG. 2, the portable electronic apparatus 100 is connected with the docking apparatus 200 by an I²C bus 280 utilizing the connectors 120 and 220. Both the SoC 110 and the MCU 210 are coupled to the I²C bus 280. The SoC 110 of the portable electronic apparatus 100 behaves as a master device on the I²C bus 280, while the MCU 210 of the docking apparatus 200 behaves as a slave device on the I²C bus 280. Within the docking apparatus 200, the MCU 210 and other I²C compatible devices such as the touch panel 230, the sensor IC 260 and the bridge IC 270 are all coupled to an I²C bus 290. The MCU 210 behaves as a master device on the I²C bus 290, while the touch panel 230, the sensor IC 260, and the bridge IC 270 behave as slave devices on the I²C bus 290. When the portable electronic apparatus 100 is connected to the docking apparatus 200, each of the slave devices of the docking apparatus 200 may be controlled by the SoC 110.

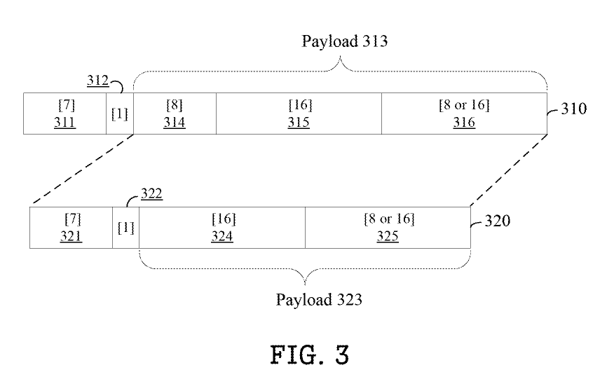

FIG. 3 illustrates a byte format of I²C messages for transmission in the docking system 10 in accordance with an embodiment of the invention. Fields of I²C messages may be located otherwise than as illustrated in FIG. 3. The term “I²C messages” refers to both I²C Commands and I²C data. Upon receiving an I²C message from the SoC 110 via the I²C bus 280, the MCU 210 translates the I²C message from a byte 310 to a byte format 320, then transmits the I²C message via the I²C bus 290. The message is received by one of the slave devices of the docking apparatus 200. Transactions on an I²C bus typically comprise a start event, a destination slave address, a read/write bit, and a number of eight bit bytes as the payload. The transactions are generally terminated by a stop event or another start event. Referring to FIG. 3, the byte format 310 comprises a slave address field 311, a read/write field 312, and a payload field 313. The payload field 313 may comprise a slave map field 314, a register address field 315, and a data field 316. The slave address field 311 is seven bits addressing a unique slave device. For example, the SoC 110 may address the MCU 210 at the slave address field 311. The subsequent read/write field 312 represents a read/write bit. The read/write bit specifies whether the slave device is to receive (typically an ‘0’ value) or to transmit (typically a ‘1’ value). The slave map field 314 is eight bits specifying a seven bit address of a slave device that is coupled to the I²C bus 290 and a read/write bit. The register address field 315 is sixteen bits addressing a register of the slave device. The data field 316 (containing data) is eight bits or sixteen bits and this goes into the register or reads from the register depending on the read/write bit. The byte format 320 comprises a slave address field 321, a read/write field 322, and a payload field 323. The payload field 323 may comprise a register address field 324 and a data field 325.

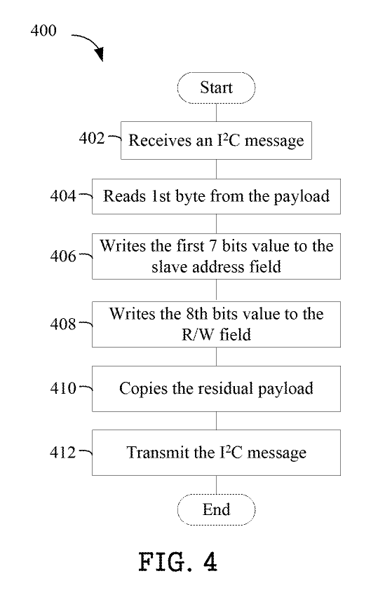

FIG. 4 illustrates a flowchart for I²C message translation in the docking system 10 in accordance with an embodiment of the invention. An example method 400 is provided by way of example, as there are a variety of ways to carry out the method. The method 400 described below can be carried out using the MCU 210 of the docking apparatus 200 illustrated in FIGS. 1 and 2, for example, and various elements of these figures are referenced in explaining the example method 400. Each block shown in FIG. 4 represents one or more processes, methods, or subroutines carried out in the exemplary method 400. The illustrated order of blocks is by example only and the order of the blocks can change according to the present disclosure. The exemplary method 400 can begin at block 402.

At block 402, the MCU 210 receives an I²C message which is sent by the SoC 110 over the I²C bus 280. The I²C message is in the byte format 310. At block 404, the MCU 210 reads and extracts the first byte value from the payload field 313 of the incoming I²C message. The first byte of the payload field 313 is the slave map field 314. At block 406, the MCU 210 writes the values of the first seven bits to the slave address field 321, to prepare an outgoing I²C message in the byte format 320. At block 408, the MCU 210 writes the value of the eighth bit to the read/write field 322 of the outgoing I²C message. At block 410, the MCU 210 copies the residual payload data, which are the values of the register address field 315 and the data field 316, to the register address field 324 and the data field 325 of the outgoing I²C message. After translating the incoming I²C message in byte format 310 to the byte format 320, the MCU 210 transmits the translated I²C message to a corresponding slave device over the I²C bus 290, at block 412. In this example embodiment, the SoC 110 communicates with the MCU 210 via the I²C bus 280 using the I²C message in the byte format 310. The MCU 210 translates the I²C message from byte format 310 to the byte format 320. The MCU 210 then uses the translated I²C message in byte format 320 to communicate with one of the slave devices, which can be the touch panel 230, the sensor IC 260, or the bridge IC 270, via the I²C bus 290. Thus, any slave device that is coupled to the MCU 210 can be directly controlled by the SoC 110.

The embodiments shown and described above are only examples. Many details are often found in the art such as the other features of a docking apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A docking apparatus comprising:
a microcontroller unit;
a first I²C bus coupled to the microcontroller unit;
a second I²C bus coupled to the microcontroller unit; and
an I²C-compatible device coupled to the second I²C bus,
wherein the microcontroller unit is configured to:
receive an I²C message in a first byte format over the first I²C bus;
translate the I²C message from the first byte format to a second byte format; and
transmit the translated I²C message over the second I²C bus.

2. The docking apparatus of claim 1, wherein the microcontroller unit behaves as a slave unit on the first I²C bus.

3. The docking apparatus of claim 2, wherein the microcontroller unit behaves as a master unit on the second I²C bus and the I²C-comaptible device behaves as a slave device on the second I²C bus.

4. The docking apparatus of claim 1, wherein the first byte format specifies a plurality of fields comprising at least a slave map field for an eight bits value where the first seven bits representing an address of one of the I²C-compatible devices and the eighth bit representing a read/write bit.

5. The docking apparatus of claim 1, wherein the second byte format specifies a plurality of fields comprising a slave address field for value representing an address of one of the I²C-compatible devices, a read/write field for value representing a read/write bit, and a payload field for value representing payload data.

6. A method for controlling a docking apparatus using a portable electronic device, the method comprising:
receiving an I²C message in a first byte format from the portable electronic device over a first I2C bus;
translating the I²C message from the first byte format to a second byte format; and
transmitting the translated I²C message over a second I²C bus to an I²C-compatible device.

7. The method of claim 6, wherein the first byte format specifies a plurality of fields comprising a slave map field for an eight bits value where the first seven bits representing an address of one of the I²C-compatible devices and the eighth bit representing a read/write bit, a register address field, and a data field.

8. The method of claim 7, wherein the second byte format specifies a plurality of fields comprising a slave address field for value representing an address of one of the I²C-compatible devices, a read/write field for value representing a read/write bit, and a payload field for value representing payload data.

9. The method of claim 8, wherein translating the I²C message from the first byte format to the second byte format comprises:
writing the first seven bits value of the slave map field to the slave address field; and
writing the eighth bit value of the slave map field to the read/write field.

10. The method of claim 9, wherein translating the I²C message from the first byte format to the second byte format further comprises:
copying value of the register address field and the data field to the payload field.
